(19) United States
(12) Patent Application Publication
(10) Pub. No.: US 2016/0053853 A1
(43) Pub. Date: Feb. 25, 2016

(54) HIGH STRENGTH INVERTED TOOTH CHAIN HAVING A PRESS-FIT MIDDLE PLATE

(71) Applicants: Schaeffler Technologies AG & Co. KG, Herzogenaurach (DE); Schaeffler Group USA, Inc., Fort Mill, SC (US)

(72) Inventor: Lucian BOTEZ, Novi, MI (US)

(73) Assignees: Schaeffler Technologies AG & Co. KG, Herzogenaurach (DE); Schaeffler Group USA, Inc., Fort Mill, SC (US)

(21) Appl. No.: 14/803,455

(22) Filed: Jul. 20, 2015

Related U.S. Application Data
(60) Provisional application No. 62/040,762, filed on Aug. 22, 2014.

(51) Int. Cl. F16G 13/04; F16H 55/30; F16G 13/06

(52) U.S. Cl. CPC F16G 13/04; F16G 13/06; F16H 55/303

(57) ABSTRACT

An inverted tooth chain assembly including outer links, middle links, inner links, and a chain pin having a diameter is provided. The inverted tooth chain assembly includes first and second packs of inner links. Each of the packs includes a predetermined number (N) of links. The inner links have a thickness (t), an outer surface depth (s₁) defined between an outer diameter of one of the third chain pin openings and an outer surface of the inner link, an outer flank depth (s₂) defined between the outer diameter of one of the third chain pin openings and an outer flank surface, and an inner flank depth (s₃) defined between the outer diameter of one of the third chain pin openings and an inner flank surface. The outer surface depth, outer flank depth, inner flank depth, thickness, and number of inner links are selected to satisfy certain relationships.

### INCORPORATION BY REFERENCE

The following document is incorporated herein by reference as if fully set forth: U.S. Provisional Patent Application No. 62/040,762 filed Aug. 22, 2014.

### FIELD OF INVENTION

This application is generally related to an inverted tooth chain assembly, and is more particularly related to an improved configuration for inner links on an inverted tooth chain assembly.

### BACKGROUND

Inverted tooth chain assemblies are used in connection with sprockets for drive assemblies in automotive and various other applications. In the prior known inverted tooth chain assemblies, the chain is formed from a number of links, each including a pair of outer flanks that are configured to engage in driving connection with teeth on a sprocket, and a pair of inner flanks. It is common practice to prestress the links by loading the chain assembly close to its breaking point in order to harden the inner link material. The residual stresses caused by prestressing increases the fatigue strength of the inner links. It is also known to increase the link thickness or to increase the number of links in an inverted tooth chain assembly in order to increase fatigue strength. Increasing the inner link thickness or adding additional links to the inner link package creates an inner link package with increased strength, and the inner links can then withstand greater stresses than the chain pin. However, this condition leads to the chain pin breaking during prestressing and therefore the inner link package cannot be work hardened to the desired level. It would be desirable to minimize the complexity of manufacturing an increased strength inverted tooth chain assembly without increasing the overall width of the chain.

### SUMMARY

An inverted tooth chain assembly configured to mesh with a sprocket that includes a modified inner link configuration is provided. The inverted tooth chain assembly includes first and second rows of outer links, and each of the outer links includes first chain pin openings. The inverted tooth chain assembly includes at least one row of middle links, and each one of the middle links includes second chain pin openings. Chain pins having a diameter (d) extends through the first and the second chain pin openings, and the outer links and the middle links are press-fitted onto respective ones of the chain pins. The inverted tooth chain assembly includes at least first and second packs of inner links. Each of the packs of inner links includes a predetermined number of links. The first pack of the inner links are arranged between the first row of the outer links and the at least one row of middle links. The second pack of the inner links are arranged between the second row of the outer links and the at least one row of middle links. Each of the inner links have two teeth with a pair of inner flanks, a pair of outer flanks, tips interconnecting respective ones of the inner and the outer flanks, and a radiused crotch located between the pair of inner flanks. Each of the inner links include third chain pin openings, and the chain pins extend through respective one of the third chain pin openings of each of the inner links so that the inner links are articulable relative to the links in adjacent rows. The inner links have a thickness (t), an outer surface depth (s₁) defined between an outer diameter of one of the third chain pin openings and an outer surface of the inner link, an outer flank depth (s₂) defined between the outer diameter of one of the third chain pin openings and an outer flank surface, and an inner flank depth (s₃) defined between the outer diameter of one of the third chain pin openings and an inner flank surface. The outer surface depth, outer flank depth, inner flank depth, thickness, and a number (N) of the inner links are selected to satisfy the following relationships:

$$\begin{matrix}8 \leq ( {s}_{1} + min ( {s}_{2} , {s}_{3} ) ) \cdot N \cdot t \leq 9 \\ and & ( 1 ) \\ 0.2 \leq \frac{{( N \cdot t )}^{2}}{{d}^{3}} \leq 0.4 & ( 2 )\end{matrix}$$

### BRIEF DESCRIPTION OF THE DRAWINGS

The foregoing Summary as well as the following Detailed Description will be best understood when read in conjunction with the appended drawings. In the Drawings:

FIG. 1 is a perspective view of a chain and sprocket drive system according to the invention.

FIG. 2 is a top cross-sectional view of the chain of FIG. 1 as partially assembled.

FIG. 3 is a front view of an inner link of the chain and sprocket drive system of FIGS. 1 and 2.

FIG. 4 is a side view of the inner link of FIG. 3.

### DETAILED DESCRIPTION OF THE PREFERRED EMBODIMENTS

Certain terminology is used in the following description for convenience only and is not limiting. The words “inner,” “outer,” “inwardly,” and “outwardly” refer to directions towards and away from the parts referenced in the drawings. A reference to a list of items that are cited as “at least one of a, b, or c” (where a, b, and c represent the items being listed) means any single one of the items a, b, or c, or combinations thereof. The terminology includes the words specifically noted above, derivates thereof, and words of similar import.

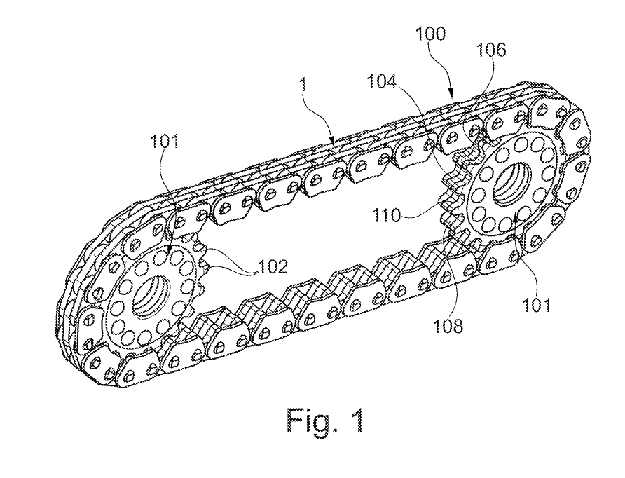

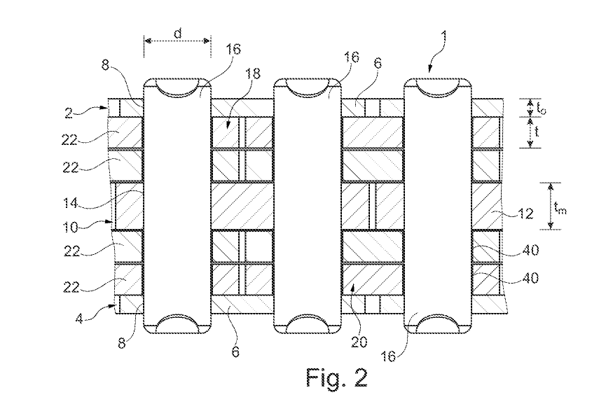

FIG. 1 shows a chain and sprocket assembly 100 including an inverted tooth chain assembly 1 configured to mesh with sprockets 101. The sprocket 101 includes a plurality of teeth 102, each of the plurality of teeth 102 have an engaging flank 104, a disengaging flank 106, a radiused tip 108 interconnecting the engaging flank 104 and the disengaging flank 106, and a root 110 located between adjacent teeth 102 of the plurality of teeth 102. The engaging flanks 104 of the teeth 102 of the sprocket 101 engage with respective flanks formed on links of an inverted tooth chain assembly 1, which is shown in more detail in FIG. 2. The inverted tooth chain assembly 1 includes a first row 2 of outer links 6 and a second row 4 of outer links 6, and each of the outer links 6 includes first chain pin openings 8. The inverted tooth chain assembly 1 includes at least one row 10 of middle links 12, and each one of the middle links 12 includes second chain pin openings 14. Chain pins 16 having a diameter (d) extend through the first chain pin openings 8 and the second chain pin openings 14, and the outer links 6 and the middle links 12 are press-fitted onto respective chain pins 16.

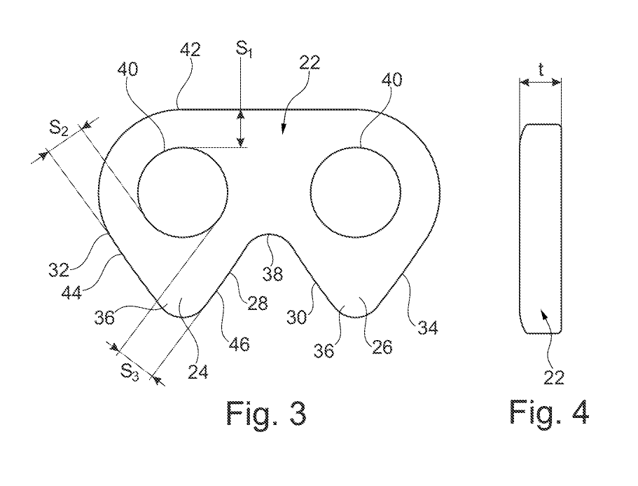

The inverted tooth chain assembly includes first packs 18 of inner links 22 and second packs 20 of inner links 22. Each of the packs 18, 20 of inner links 22 includes a predetermined number of links (N). In one preferred embodiment, the first pack 18 of inner links 22 and the second pack 20 of inner links 22 have the same number of the inner links 22. In another preferred embodiment, the first pack 18 of inner links 22 and the second pack 20 of inner links 22 each include two rows of inner links 22. The first pack 18 of the inner links 22 are arranged between the first row 2 of the outer links 6 and the at least one row 10 of middle links 12. The second pack 20 of the inner links 22 are arranged between the second row 4 of the outer links 6 and the at least one row 10 of middle links 12. As shown in FIG. 3, each of the inner links 22 have two teeth 24, 26 with a pair of inner flanks 28, 30, and a pair of outer flanks 32, 34. The inner links 22 have tips 36 interconnecting respective ones of the inner and outer flanks 28, 32 and 30, 34, and a radiused crotch 38 is located between the pair of inner flanks 28, 30. Each of the inner links 22 include third chain pin openings 40, and the chain pins 16 extend through respective ones of the third chain pin openings 40 of each of the inner links 22 so that the inner links 22 are articulable relative to the links in adjacent rows.

The characteristics of the inner links 22 disclosed below are selected to provide increased strength without greatly increasing the thickness of the overall assembly 1. The inner links 22 have a thickness (t), an outer surface depth (s₁) defined between an outer diameter of one of the third chain pin openings 40 and an outer surface 42 of the inner link 22, an outer flank depth (s₂) defined between the outer diameter of one of the third chain pin openings 40 and an outer flank surface 44, and an inner flank depth (s₃) defined between the outer diameter of one of the third chain pin openings 40 and an inner flank surface 46. The depths (s₁, s₂, s₃) are defined at the typical fracture locations of the inner links 22. The outer surface depth (s₁), outer flank depth (s₂), inner flank depth (s₃), thickness (t), number of inner links (N), and diameter (d) of the chain pin 16 are selected to satisfy the following relationships:

$$\begin{matrix}8 \leq ( {s}_{1} + min ( {s}_{2} , {s}_{3} ) ) \cdot N \cdot t \leq 9 \\ and & ( 1 ) \\ 0.2 \leq \frac{{( N \cdot t )}^{2}}{{d}^{3}} \leq 0.4 & ( 2 )\end{matrix}$$

The function “min(s₂, s₃)” determines the smallest depth value between s₂ and s₃. In one preferred embodiment, the thickness (t) of the inner links 22 is greater than a thickness (tₒ) of the outer links 6, and the thickness (t) of the inner links 22 is less than a thickness (tₘ) of the middle links 12. In one preferred embodiment, the inner flank depth (s₃) is greater than the outer flank depth (s₂). In another preferred embodiment, the inner flank depth (s₃) is less than the outer flank depth (s₂). In another preferred embodiment, the outer surface depth (s₁) is less than the outer flank depth (s₂), and less than the inner flank depth (s₃).

Having thus described various embodiments of the present chain and sprocket drive system in detail, it is to be appreciated and will be apparent to those skilled in the art that many physical changes, only a few of which are exemplified in the detailed description above, could be made in the apparatus without altering the inventive concepts and principles embodied therein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

What is claimed is:

1. An inverted tooth chain assembly configured to mesh with a sprocket, the inverted tooth chain assembly comprising:
first and second rows of outer links, each of the outer links including first chain pin openings;
at least one row of middle links, each of the middle links including second chain pin openings;
chain pins having a diameter (d) and extending through the first chain pin openings and the second chain pin openings, the outer links and the middle links are press-fitted onto respective ones of the chain pins; and
at least first and second packs of inner links, each of the packs of inner links including a predetermined number of inner links (N), the first pack of the inner links arranged between the first row of the outer links and the at least one row of middle links, the second pack of the inner links arranged between the second row of the outer links and the at least one row of middle links,
each of the inner links having two teeth with a pair of inner flanks, a pair of outer flanks, tips interconnecting respective ones of the inner and the outer flanks, and a radiused crotch located between the pair of inner flanks,
each of the inner links including third chain pin openings, and having a thickness (t), an outer surface depth (s₁) defined between an outer diameter of one of the third chain pin openings and an outer surface of the inner link, an outer flank depth (s₂) defined between the outer diameter of one of the third chain pin openings and an outer flank surface, and an inner flank depth (s₃) defined between the outer diameter of one of the third chain pin openings and an inner flank surface, the chain pins extending through respective ones of the third chain pin openings of each of the inner links so that the inner links are articulable relative to the links in adjacent rows, wherein the following relationships are satisfied:
$$\begin{matrix}8 \leq ( {s}_{1} + min ( {s}_{2} , {s}_{3} ) ) \cdot N \cdot t \leq 9 \\ and & ( 1 ) \\ 0.2 \leq \frac{{( N \cdot t )}^{2}}{{d}^{3}} \leq 0.4 & ( 2 )\end{matrix}$$

2. The inverted tooth chain assembly of claim 1, wherein the thickness (t) of the inner links is greater than a thickness (tₒ) of the outer links, and the thickness (t) of the inner links is less than a thickness (tₘ) of the middle links.

3. The inverted tooth chain assembly of claim 1, wherein the first pack of inner links and the second pack of inner links have a same number of the inner links.

4. The inverted tooth chain assembly of claim 1, wherein the inner flank depth (s₃) is greater than the outer flank depth (s₂).

5. The inverted tooth chain assembly of claim 1, wherein the inner flank depth (s₃) is less than the outer flank depth (s₂).

6. The inverted tooth chain assembly of claim 1, wherein the outer surface depth (s₁) is less than the outer flank depth (s₂) and less than the inner flank depth (s₃).

7. The inverted tooth chain assembly of claim 1, wherein the first pack of inner links and the second pack of inner links each include two rows of inner links.

8. A chain and sprocket drive system comprising:
a sprocket including a plurality of teeth, each of the plurality of teeth having an engaging flank, a disengaging flank, a radiused tip interconnecting the engaging flank and the disengaging flank, and a root located between adjacent teeth of the plurality of teeth; and
an inverted tooth chain assembly configured to mesh with the sprocket, the inverted tooth chain assembly comprising:
first and second rows of outer links, each of the outer links including first chain pin openings;
at least one row of middle links, each one of the middle links including second chain pin openings;
chain pins having a diameter (d) and extending through the first and the second chain pin openings, the outer links and the middle links are press-fitted onto respective ones of the chain pins; and
at least first and second packs of inner links, each of the packs of inner links including a predetermined number of inner links (N), the first pack of the inner links arranged between the first row of the outer links and the at least one row of middle links, the second pack of the inner links arranged between the second row of the outer links and the at least one row of middle links,
each of the inner links having two teeth with a pair of inner flanks, a pair of outer flanks, tips interconnecting respective ones of the inner and the outer flanks, and a radiused crotch located between the pair of inner flanks,
each of the inner links including third chain pin openings, and having a thickness (t), an outer surface depth (s₁) defined between an outer diameter of one of the third chain pin openings and an outer surface of the inner link, an outer flank depth (s₂) defined between the outer diameter of one of the third chain pin openings and an outer flank surface, and an inner flank depth (s₃) defined between the outer diameter of one of the third chain pin openings and an inner flank surface, the chain pins extending through respective ones of the third chain pin openings of each of the inner links so that the inner links are articulable relative to the links in adjacent rows, wherein the following relationships are satisfied:
$$\begin{matrix}8 \leq ( {s}_{1} + min ( {s}_{2} , {s}_{3} ) ) \cdot N \cdot t \leq 9 \\ and & ( 1 ) \\ 0.2 \leq \frac{{( N \cdot t )}^{2}}{{d}^{3}} \leq 0.4 & ( 2 )\end{matrix}$$
